(19) United States
(12) Patent Application Publication
(10) Pub. No.: US 2019/0036578 A1
(43) Pub. Date: Jan. 31, 2019

(54) TECHNIQUES TO REDUCE RADIATED POWER FOR MIMO WIRELESS SYSTEMS

(71) Applicant: NOKIA SOLUTIONS AND NETWORKS OY, Espoo (FI)

(72) Inventors: Wolfgang Zirwas, Munich (DE); Berthold Panzner, Holzkirchen (DE); Simone Redana, Munich (DE); Stefan Dierks, Munich (DE); Markus Staudacher, Munich (DE); Gerhard Kramer, Munich (DE)

(21) Appl. No.: 15/766,695

(22) PCT Filed: Oct. 7, 2015
(86) PCT No.: PCT/EP2015/073096

§ 371 Date: Apr. 6, 2018

(51) Int. Cl. H04B 7/0456

(52) U.S. Cl. CPC H04B 7/0465; H04B 7/0469

(57) ABSTRACT

A technique is provided for selecting precoding weights in a wireless network to avoid violating a power constraint. The technique may include selecting, by an access point in a wireless network, a set of precoding weights subject to a power constraint, and applying, by the access point, the set of selected precoding weights to a set of antennas to transmit signals to the one or more user devices. Selecting a set of precoding weights may further include calculating, by the access point, the set of precoding weights for each of a plurality of beamformed signals; determining, by the access point, that the set of precoding weights for the plurality of beamformed signals, when applied to a set of antennas for transmitting signals to the one or more user devices, will violate a power constraint; determining, by the access point, that a first set of precoding weights for a first beamformed signal causes a power contribution that is greater than power contributions due to sets of precoding weights of the other beamformed signals; adjusting, by the access point, one or more precoding weights of the first set of precoding weights for the first beamformed signal such that the power constraint will not be violated when the access point applies the precoding weights, including the adjusted first set of precoding weights, to a set of antennas and transmits signals to the plurality of user devices.

### TECHNICAL FIELD

This description relates to communications.

### BACKGROUND

A communication system may be a facility that enables communication between two or more nodes or devices, such as fixed or mobile communication devices. Signals can be carried on wired or wireless carriers.

An example of a cellular communication system is an architecture that is being standardized by the 3^{rd} Generation Partnership Project (3GPP). A recent development in this field is often referred to as the long-term evolution (LTE) of the Universal Mobile Telecommunications System (UMTS) radio-access technology. E-UTRA (evolved UMTS Terrestrial Radio Access) is the air interface of 3GPP′s Long Term Evolution (LTE) upgrade path for mobile networks. In LTE, base stations or access points (APs), which are referred to as enhanced Node AP (eNBs), provide wireless access within a coverage area or cell. In LTE, mobile devices, or mobile stations are referred to as user equipments (UE). LTE has included a number of improvements or developments.

A global bandwidth shortage facing wireless carriers has motivated the consideration of the underutilized millimeter wave (mmWave) frequency spectrum for future broadband cellular communication networks, for example. mmWave (or extremely high frequency) may, for example, include the frequency range between 30 and 300 gigahertz (GHz). Radio waves in this band may, for example, have wavelengths from ten to one millimeters, giving it the name millimeter band or millimeter wave. The amount of wireless data will likely significantly increase in the coming years. Various techniques have been used in attempt to address this challenge including obtaining more spectrum, having smaller cell sizes, and using improved technologies enabling more bits/s/Hz. One element that may be used to obtain more spectrum is to move to higher frequencies, above 6 GHz. For fifth generation wireless systems (5G), an access architecture for deployment of cellular radio equipment employing mmWave radio spectrum has been proposed.

Precoding is a technique which exploits transmit diversity by weighting an information stream at the transmitter based on knowledge of the channel between a base station and a mobile station. For example, in some cases, multiple data streams are transmitted from multiple transmit antennas with independent weightings such that data throughput and/or received signal quality at the receiver may be improved.

### SUMMARY

According to an example implementation, a method includes selecting, by an access point in a wireless network, a set of precoding weights subject to a power constraint; and applying, by the access point, the set of selected precoding weights to a set of antennas to transmit signals to the one or more user devices.

According to another example implementation, an apparatus may include at least one processor and at least one memory including computer instructions, when executed by the at least one processor, cause the apparatus to: select, by an access point in a wireless network, a set of precoding weights subject to a power constraint; and apply, by the access point, the set of selected precoding weights to a set of antennas to transmit signals to the one or more user devices.

According to another example implementation, a computer program product comprising a computer-readable storage medium and storing executable code that, when executed by at least one data processing apparatus, is configured to cause the at least one data processing apparatus to perform a method including: selecting, by an access point in a wireless network, a set of precoding weights subject to a power constraint; and applying, by the access point, the set of selected precoding weights to a set of antennas to transmit signals to the one or more user devices.

According to another example implementation, a method may include determining, by an access point in a wireless network, a set of antenna-related parameters; selecting, by the access point, based on the set of antenna-related parameters, a set of precoding weights to improve a utility function; and applying, by the access point, the set of selected precoding weights to a set of antennas to transmit signals to the one or more user devices.

According to another example implementation an apparatus may include at least one processor and at least one memory including computer instructions, when executed by the at least one processor, cause the apparatus to: determine, by an access point in a wireless network, a set of antenna-related parameters; select, by the access point, based on the set of antenna-related parameters, a set of precoding weights to improve a utility function; and apply, by the access point, the set of selected precoding weights to a set of antennas to transmit signals to the one or more user devices.

According to another example implementation, a computer program product may include a computer-readable storage medium and storing executable code that, when executed by at least one data processing apparatus, is configured to cause the at least one data processing apparatus to perform a method including: determining, by an access point in a wireless network, a set of antenna-related parameters; selecting, by the access point, based on the set of antenna-related parameters, a set of precoding weights to improve a utility function; and applying, by the access point, the set of selected precoding weights to a set of antennas to transmit signals to the one or more user devices.

The details of one or more examples of implementations are set forth in the accompanying drawings and the description below. Other features will be apparent from the description and drawings, and from the claims.

### BRIEF DESCRIPTION OF THE DRAWINGS

FIG. 1 is a block diagram of a wireless network according to an example implementation.

FIG. 2 is a diagram of a wireless transceiver according to an example implementation.

FIG. 3 is a flow chart illustrating operation of an access point according to an example implementation.

FIG. 4 is a flow chart illustrating operation of an access point according to another example implementation.

FIG. 5 is a diagram illustrating a massive MIMO deployment and a network MIMO deployment according to an example implementation.

FIG. 6 is a diagram illustrating a example histogram.

FIG. 7 is an example normalized transmit power pattern for 20 transmit antennas.

FIG. 8 is an example normalized transmit power pattern for 200 transmit antennas.

FIG. 9 is an example normalized transmit power pattern for 40 transmit antennas.

FIG. 10 is a diagram illustrating the application of summed precoding weights for multiple user devices/user equipment (UEs) to antennas according to an example implementation.

FIG. 11 is a diagram illustrating spectral efficiency of the example implementation that reduces decoding weights for only one UE or a subset of UEs, as compared to spectral efficiency of an EIRP reduction techniques that reduce power for all UEs by a fixed amount, e.g., 3 dB, 6 dB or 10 dB, to avoid EIRP violations.

FIG. 12 is a block diagram of a wireless station (e.g., AP or user device) 1200 according to an example implementation.

### DETAILED DESCRIPTION

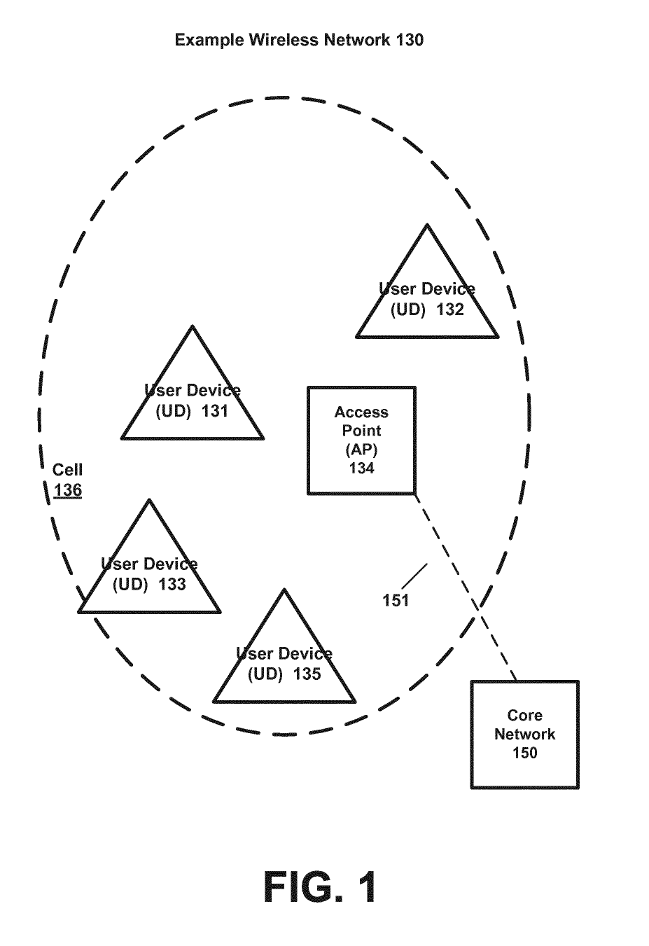

FIG. 1 is a block diagram of a wireless network 130 according to an example implementation. In the wireless network 130 of FIG. 1, user devices 131, 132, 133 and 135, which may also be referred to as user devices (UDs), may be connected (and in communication) with an access point (AP), which may also be referred to as a base station (BS) or an enhanced Node B (eNB). At least part of the functionalities of an access point (AP), base station (BS) or (e)Node B (eNB) may be also be carried out by any node, server or host which may be operably coupled to a transceiver, such as a remote radio head. AP 134 provides wireless coverage within a cell 136, including to user devices 131, 132, 133 and 135. Although only four user devices are shown as being connected or attached to AP 134, any number of user devices may be provided. AP 134 is also connected to a core network 150 via a 51 interface 151. This is merely one simple example of a wireless network, and others may be used.

A user device (user terminal, user equipment (UE)) may refer to a portable computing device that includes wireless mobile communication devices operating with or without a subscriber identification module (SIM), including, but not limited to, the following types of devices: a mobile station, a mobile phone, a cell phone, a smartphone, a personal digital assistant (PDA), a handset, a device using a wireless modem (alarm or measurement device, etc.), a laptop and/or touch screen computer, a tablet, a phablet, a game console, a notebook, and a multimedia device, as examples. It should be appreciated that a user device may also be a nearly exclusive uplink only device, of which an example is a camera or video camera loading images or video clips to a network.

In LTE (as an example), core network 150 may be referred to as Evolved Packet Core (EPC), which may include a mobility management entity (MME) which may handle or assist with mobility/handover of user devices between BSs, one or more gateways that may forward data and control signals between the BSs and packet data networks or the Internet, and other control functions or blocks.

The various example implementations may be applied to a wide variety of wireless technologies or wireless networks, such as LTE, LTE-A, 5G, and/or mmWave band networks, or any other wireless network. LTE, 5G and mmWave band networks are provided only as illustrative examples, and the various example implementations may be applied to any wireless technology/wireless network.

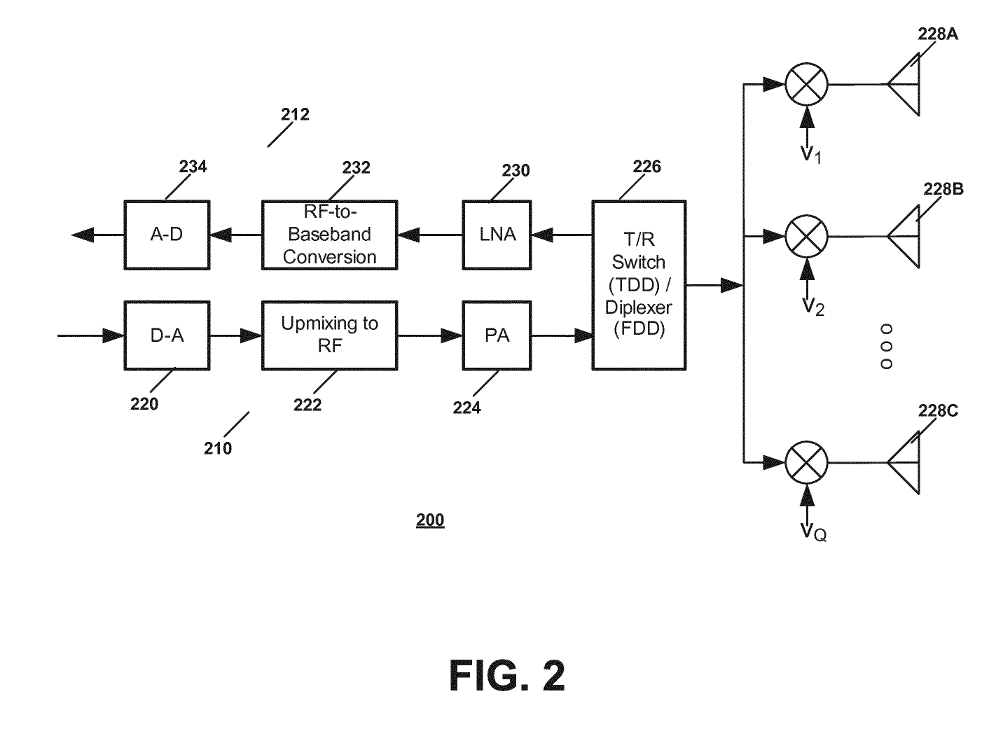

FIG. 2 is a diagram of a wireless transceiver according to an example implementation. Wireless transceiver 200 may be used, for example, at a base station (BS), e.g., Access Point (AP) or eNB, or other wireless device. Wireless transceiver 200 may include a transmit path 210 and a receive path 212.

In transmit path 210, a digital-to-analog converter (D-A) 220 may receive a digital signal from one or more applications and convert the digital signal to an analog signal. Upmixing block 222 may up-convert the analog signal to an RF (e.g., radio frequency) signal. Power amplifier (PA) 224 then amplifies the up-converted signal. The amplified signal is then passed through a transmit/receive (T/R) switch (or Diplexer 226 for frequency division duplexing, to change frequencies for transmitting). The signal output from T/R switch 226 is then output to one or more antennas in an array of antennas 228, such as to antenna 228A, 228B and/or 228C. Prior to being transmitted by one or more of the antennas in the array of antennas 228, a set of beam weights V₁, V₂, . . . or V_{Q} is mixed with the signal to apply a gain and phase to the signal for transmission. For example, a gain and phase, V₁, V₂, . . . or V_{Q}, may be applied to the signal output from the T/R switch 226 to scale the signal transmitted by each antenna (e.g., the signal is multiplied by V₁ before being transmitted by antenna 1 228A, the signal is multiplied by V₂ before being transmitted by antenna 2 228B, and so on), where the phase may be used to steer or point a beam transmitted by the overall antenna array, e.g., for directional beam steering. Thus, the beam weights V₁, V₂, . . . or V_{Q} (e.g., each beam weight including a gain and/or phase) may be a set of transmit beamforming beam weights when applied at or during transmission of a signal to transmit the signal on a specific beam, and may be a set of receive beamforming beam weights when applied to receive a signal on a specific beam. In one illustrative example, the set of beam weights may be a set of precoding weights, with a different precoding weight applied to each antenna (or to each antenna element) of an antenna array. In an example implementation, the term ‘precoding weights’ may cover any form of antenna weighting or generation of transmit signals (TX-signals) for example for the purposes of beamfoming or other optimizations or other utility functions.

In receive path 212 of wireless transceiver 200, a signal is received via an array of antennas 228, and is input to T/R switch 226, and then to low noise amplifier (LNA) 230 to amplify the received signal. The amplified signal output by LNA 230 is then input to a RF-to-baseband conversion block 232 where the amplified RF signal is down-converted to baseband. An analog-to-digital (A-D) converter 234 then converts the analog baseband signal output by conversion block 232 to a digital signal for processing by one or more upper layers/application layers.

Precoding may, for example, be a technique that exploits array gain by weighting an information stream at the transmitter based on knowledge of the channel(s) between a base station and a mobile station. For example, in some cases, multiple data streams are transmitted from multiple transmit antennas with independent weightings such that data throughput and/or received signal quality at the receiver may be improved.

According to an illustrative example implementation, codebook-based precoding may be performed by AP 134 based on a channel(s) measured by the user device 132. In an illustrative example, AP 134 may transmit/send cell-specific reference signals that are received by the user device 132. User device 132 may measure one or more qualities of the channel between the AP 134 and user device 132 based on the received cell-specific reference signals. Based on the measured channel quality (and/or based on the received cell-specific reference signals), user device 132 may select a suitable transmission rank and a precoder matrix. User device 132 may then report this information to the AP 134 by sending the AP 134 a rank indication (RI) and a precoder matrix indication(s) (PMI). For example, a PMI k1 may be provided for codebook W1 and a PMI (precoding matrix indicator) k2 may be provided for codebook W2. The AP 134 or transmitter may perform precoding based on the selected precoder matrix for a signal stream or block(s) of data, and then transmit the precoded data/signal to the user device 132.

For example, at the AP 134, an output (transmitted/precoded) signal Y may be determined or generated based on the input signal X and the selected codebook matrix W, for example. W(k) as follows, for example: Y=W(k)*X , where W(k) is the k-th matrix from the set of W matrices (of the W codebook). After the transmission of precoded signal Y from the AP 134, the received signal at the user device 132 can be expressed as w=HY+N, where Y is the precoded signal transmitted by the AP 134, H is the channel, N is the interference+noise, and w is the received signal (received by user device 132).

In an illustrative example implementation, user device 132 may receive the signal w, and perform post processing on the received signal, e.g., to improve or even maximize SNR or SINR (signal-to-interference plus noise ratio).

In many systems, the transmit power of antennas is constrained by regulations (for example, communication regulations from the International Telecommunications Union (ITU) in Europe or the Federal Communications Commission (FCC) in the US). A main reason for these regulations is to protect the health of persons in the vicinity of transmit antennas. The regulations may define a maximum equivalent isotropically radiated power (EIRP), e.g., depending on the frequency used and on the location where the transmit antennas are placed. The EIRP may, for example, be the amount of power that a theoretical isotropically antenna (e.g., which evenly distributes power in all directions) would emit to produce the peak/maximum power density observed in the direction of maximum antenna gain. When many antennas are used to transmit, the signals from the different antennas interfere constructively in certain directions and create a certain antenna gain pattern. The constructive interference is intended as it potentially increases the received signal power at the receiver side. On the other hand, in some cases, the constructive interference can lead to violations of EIRP regulations, e.g., where a maximum power density, EIRP, or other power measurement or power output of the AP exceeds a maximum EIRP or other power threshold.

Therefore, according to an example implementation, various techniques are described that allow for an access point (AP) to select or determine a set of precoding weights for each of a plurality of user devices. According to an example implementation, the precoding weights may be determined to improve (e.g., maximize) a utility function, such as to improve (e.g., maximize) signal-to-interference plus noise ratio (SINR), data rate, or other utility function or performance parameter. In addition, the precoding parameters for each user device may also be selected and/or iteratively adjusted, to avoid violating a power constraint (e.g., to prevent the maximum power density or EIRP of the AP from exceeding a maximum EIRP or other power threshold). For example, after determining a set of precoding weights for a plurality of user devices, the power density for a plurality of directions for the AP may be compared to a maximum EIRP to determine whether a current set of precoding weights for the user devices will cause a violation of a power constraint (e.g., result in an EIRP of the AP that exceeds a maximum EIRP for any of the directions). If the precoding weights will result in a violation of a power constraint, then the AP may reduce one or more of the precoding weights such that a violation of the power constraint will not occur. In an illustrative example implementation, all or part of this process may be performed iteratively (repeated as necessary), for example, where the process may include, e.g., determining a set of precoding weights for one or more (or each of a plurality of) user devices, determining a power density (e.g., maximum power density) or EIRP for the AP, and comparing such EIRP or power density of the AP to a maximum EIRP, and then, if necessary to avoid exceeding the maximum EIRP, reducing/decreasing one or more of the precoding weights, and then calculating (or recalculating) an updated power density or EIRP and comparing the updated power density or EIRP of the AP to the maximum EIRP to determine if a violation of a power constraint will still occur. If a violation of a power constraint will still occur, then one or more of the precoding weights may be again adjusted (e.g., decreased or reduced) to further reduce the power density or EIRP for the AP. In an example implementation, the amount of adjustment (or decrease) of the precoding weights may be based upon, for example, how much the maximum power density or EIRP of the AP exceeds the maximum EIRP. A large overshoot over the maximum EIRP (e.g., a power constraint violation by a large amount) may result in a relatively large reduction to the amplitudes of the precoding weights for a user device(s), while a smaller overshoot over the maximum EIRP (e.g., a power constraint violation by a smaller amount) may typically result in a smaller adjustment(s)/decrease to the precoding weights of one or more user devices, for example.

In one example implementation, the precoding weights for all user devices may be adjusted together to reduce the power density or EIRP of the AP, e.g., to prevent a violation of a power constraint. However, by adjusting or reducing precoding weights for all user devices, all messages may be transmitted from the AP with lower power than may be possible, and may result in signal quality and/or data rate requirements not being met in the system, at least for some user devices.

In another example implementation, rather than adjusting or decreasing precoding weights for all user devices (to avoid a power constraint violation), one or more precoding weights (e.g., amplitude of the precoding weights) may be adjusted (e.g., reduced or decreased) only for one user device or a subset of the user devices. For example, the AP may measure the relative power contribution for the precoding weights for each user device, and may adjust or decrease precoding weights only for the user device (or subset of user devices) having the greatest power contribution to the power density or EIRP of the AP. In this manner, the signal strength may be reduced (via adjusting or decreasing the precoding weights) only for signals or beams transmitted to user device(s) that are most responsible for the power constraint violation, while maintaining the signal strength (maintaining the precoding weights) of other user devices that are lesser contributors to the power constraint violation (e.g., by adjusting precoding weights for user devices that are the greatest contributor to the power density/EIRP of the AP, and by not adjusting the precoding weights of other user devices). Other techniques may also be used to select one or more user devices (or precoding vectors for one or more user devices) to adjust precoding weights in order to avoid a power constraint violation.

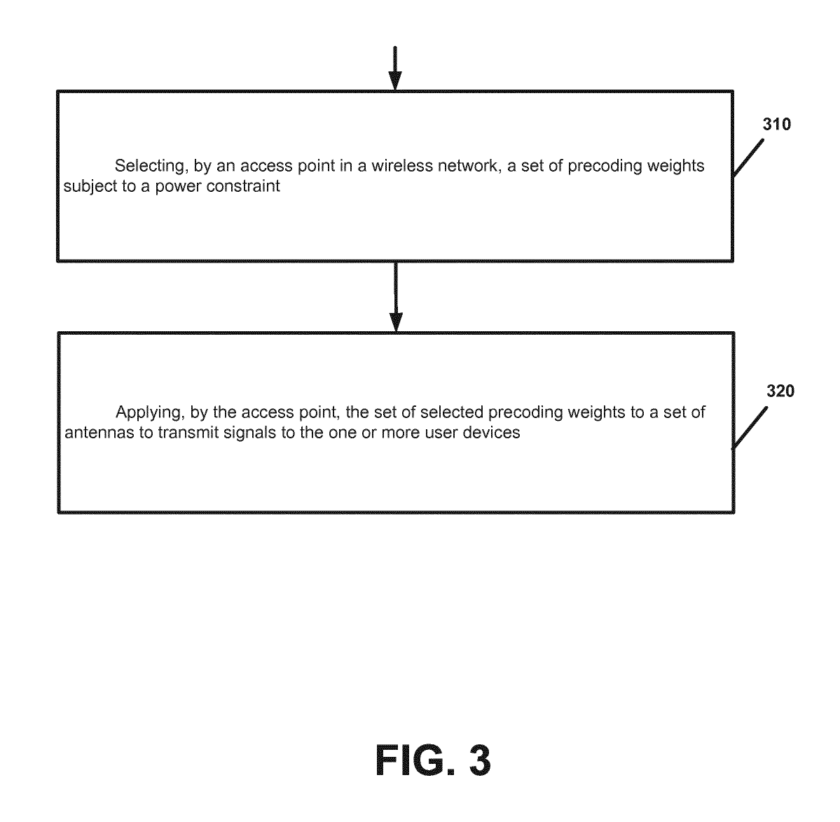

FIG. 3 is a flow chart illustrating operation of an access point according to an example implementation. The flow chart of FIG. 3 may be directed to, for example, to a method of selecting precoding weights in a wireless network to avoid violating a power constraint. Referring to the flow chart shown in FIG. 3, operation 310 includes selecting, by an access point in a wireless network, a set of precoding weights subject to a power constraint. And, operation 320 includes applying, by the access point, the set of selected precoding weights to a set of antennas to transmit signals to the one or more user devices.

According to an example implementation of the method of FIG. 3, the selecting may include: calculating, by the access point, the set of precoding weights; determining, by the access point, that the set of precoding weights, when applied to a set of antennas for transmitting signals to the one or more user devices, will violate a power constraint; and adjusting, by the access point, one or more precoding weights such that the power constraint will not be violated when the access point applies the precoding weights to a set of antennas and transmits signals to the one or more user devices.

According to an example implementation of the method of FIG. 3, the selecting may include: calculating, by the access point, the set of precoding weights for each of a plurality of beamformed signals; determining, by the access point, that the set of precoding weights for the plurality of beamformed signals, when applied to a set of antennas for transmitting signals to the one or more user devices, will violate a power constraint; determining, by the access point, that a first set of precoding weights for a first beamformed signal causes a power contribution that is greater than power contributions due to sets of precoding weights of the other beamformed signals; and, adjusting, by the access point, one or more precoding weights of the first set of precoding weights for the first beamformed signal such that the power constraint will not be violated when the access point applies the precoding weights, including the adjusted first set of precoding weights, to a set of antennas and transmits signals to the plurality of user devices.

According to an example implementation of the method of FIG. 3, the selecting may include: calculating, by the access point, the set of precoding weights; determining a set of antenna parameters for an antenna array; calculating, by the access point, a power density for each of a plurality of directions based on the set of antenna parameters and the set of precoding weights; determining a maximum power density of the calculated power densities; comparing the maximum power density to a maximum equivalent isotropically radiated power (EIRP); and, adjusting, by the access point if the maximum power density is greater than a maximum equivalent isotropically radiated power (EIRP), one or more precoding weights of at least one of the directions to reduce the maximum power density.

According to an example implementation of the method of FIG. 3, the selecting may include at least one of the following: selecting, by an access point in a wireless network, a set of precoding weights for to maximize a data rate without violating a power constraint; and selecting, by an access point in a wireless network, a set of precoding weights to maximize a signal-to-interference plus noise ratio (SINR) without violating a power constraint.

According to an example implementation of the method of FIG. 3, the power constraint may include, for example: a maximum power density or an equivalent isotropically radiated power (EIRP) from the access point that is less than or equal to a maximum equivalent isotropically radiated power (EIRP).

According to an example implementation, an apparatus may include at least one processor and at least one memory including computer instructions, when executed by the at least one processor, cause the apparatus to: select, by an access point in a wireless network, a set of precoding weights subject to a power constraint; and apply, by the access point, the set of selected precoding weights to a set of antennas to transmit signals to the one or more user devices.

A computer program product comprising a computer-readable storage medium and storing executable code that, when executed by at least one data processing apparatus, is configured to cause the at least one data processing apparatus to perform a method including: selecting, by an access point in a wireless network, a set of precoding weights subject to a power constraint; and applying, by the access point, the set of selected precoding weights to a set of antennas to transmit signals to the one or more user devices.

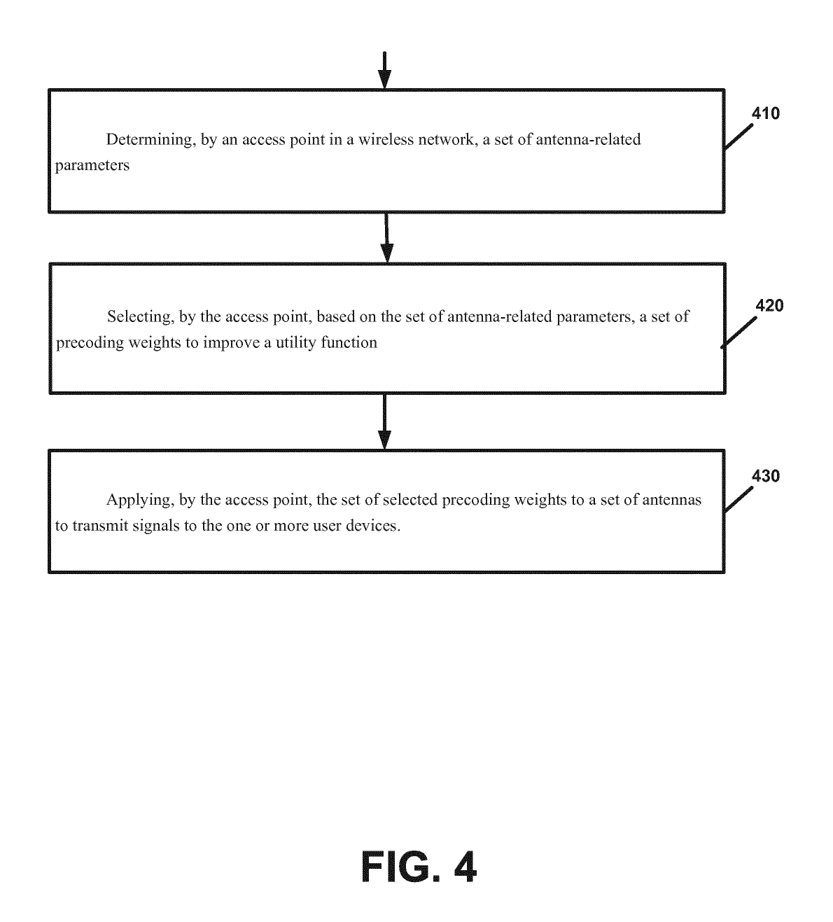

FIG. 4 is a flow chart illustrating operation of an access point according to another example implementation. The flow chart of FIG. 4 may be directed to a method of selecting precoding weights based on a set of antenna-related parameters. Referring to FIG. 4, operation 410 may include determining, by an access point in a wireless network, a set of antenna-related parameters. Operation 420 may include selecting, by the access point, based on the set of antenna-related parameters, a set of precoding weights to improve a utility function. And, operation 430 may include applying, by the access point, the set of selected precoding weights to a set of antennas to transmit signals to the one or more user devices.

According to an example implementation of the method of FIG. 4, the determining, by an access point in a wireless network, a set of antenna-related parameters for one or more user devices may include: storing, by the access point in a memory of the access point, the antenna-related parameters; and retrieving the antenna-related parameters from memory.

According to an example implementation of the method of FIG. 4, the antenna-related parameters are specified by one or more antenna vendors or antenna manufacturers.

According to an example implementation of the method of FIG. 4, the determining, by an access point in a wireless network, a set of antenna-related parameters may include: transmitting, by the access point to the one or more user devices, antenna specific reference signals used for the estimation of antenna-related channel state information at user devices; receiving, by the access point, from the one or more user devices, the accordingly estimated channel state information to the access point, together with user device location information; and determining, by the access point, the antenna-related parameters based on the channel state information and the user device location information received from the one or more user devices.

According to an example implementation of the method of FIG. 4, the selecting may include: selecting, by the access point in a wireless network, a set of precoding weights for each of one or more user devices to improve a utility function and avoid violating a power constraint.

According to an example implementation of the method of FIG. 4, the antenna-related parameters may include parameters that indicate or describe one or more of the following: geometrical allocation of antenna elements; beam patterns per antenna element; and other antenna characteristics.

According to an example implementation of the method of FIG. 4, the selecting may include at least one of the following: selecting, by an access point in a wireless network, a set of precoding weights to improve a data rate or SINR (signal-to-interference plus noise ratio); selecting, by an access point in a wireless network, a set of precoding weights to improve energy efficiency; and selecting, by an access point in a wireless network, a set of precoding weights to improve wireless coverage for one or more user devices.

According to an example implementation, the selecting may be performed subject to a power constraint.

According to an example implementation of the method of FIG. 4, the selecting may include: selecting, by an access point in a wireless network, a set of precoding weights subject to a plurality of directional power constraints, with each directional power constraint indicating a maximum power for a different direction.

According to an example implementation of the method of FIG. 4, the directional power constraints vary depending on time, location, placement, surrounding or other criteria.

According to an example implementation of the method of FIG. 4, the selecting may include: calculating, by the access point, the set of precoding weights; determining, by the access point, that the set of precoding weights, when applied to a set of antennas for transmitting signals to the one or more user devices, will violate a power constraint; and adjusting, by the access point, one or more precoding weights such that the power constraint will not be violated when the access point applies the precoding weights to a set of antennas and transmits signals to the one or more user devices.

According to an example implementation of the method of FIG. 4, the selecting may include: calculating, by the access point, the set of precoding weights for each of a plurality of beamformed signals; determining, by the access point, that the set of precoding weights for the plurality of beamformed signals, when applied to a set of antennas for transmitting signals to the one or more user devices, will violate a power constraint; determining, by the access point, that a first set of precoding weights for a first beamformed signal causes a power contribution that is greater than power contributions due to sets of precoding weights of the other beamformed signals; adjusting, by the access point, one or more precoding weights of the first set of precoding weights for the first beamformed signal such that the power constraint will not be violated when the access point applies the precoding weights, including the adjusted first set of precoding weights, to a set of antennas and transmits signals to the plurality of user devices.

According to an example implementation of the method of FIG. 4, the selecting may include: calculating, by the access point, the set of precoding weights determining a set of antenna-related parameters for an antenna array; calculating, by the access point, a power density for each of a plurality of directions based on the set of antenna-related parameters and the set of precoding weights; determining a maximum power density of the calculated power densities; comparing the maximum power density to a maximum equivalent isotropically radiated power (EIRP); and, adjusting, by the access point if the maximum power density is greater than a maximum equivalent isotropically radiated power (EIRP), one or more precoding weights of at least one of the directions to reduce the maximum power density.

According to an example implementation, an apparatus may include at least one processor and at least one memory including computer instructions, when executed by the at least one processor, cause the apparatus to: determine, by an access point in a wireless network, a set of antenna-related parameters; select, by the access point, based on the set of antenna-related parameters, a set of precoding weights to improve a utility function; and apply, by the access point, the set of selected precoding weights to a set of antennas to transmit signals to the one or more user devices.

A computer program product comprising a computer-readable storage medium and storing executable code that, when executed by at least one data processing apparatus, is configured to cause the at least one data processing apparatus to perform a method including: determining, by an access point in a wireless network, a set of antenna-related parameters; selecting, by the access point, based on the set of antenna-related parameters, a set of precoding weights to improve a utility function; and applying, by the access point, the set of selected precoding weights to a set of antennas to transmit signals to the one or more user devices.

Further illustrative details and features will now be described for various example implementations.

An example of precoding for a wireless network may include an access point determining a precoding vector for each of a plurality of user devices based on a channel between the access point and the user device. Each precoding vector may include a set of precoding weights, with each precoding weight applied to an antenna of an antenna array at an access point to transmit to the user device for MIMO. Multiple User MIMO (or MU-MIMO) may allow, for example, the access point to transmit different data to different user devices via the same time-frequency resources, based on, for example, the use of a different precoding vector (each precoding vector including a set or column of precoding weights) for each user device. Respective (or corresponding) precoding weights for each user device may be added or summed and then applied to the corresponding antenna of the antenna array.

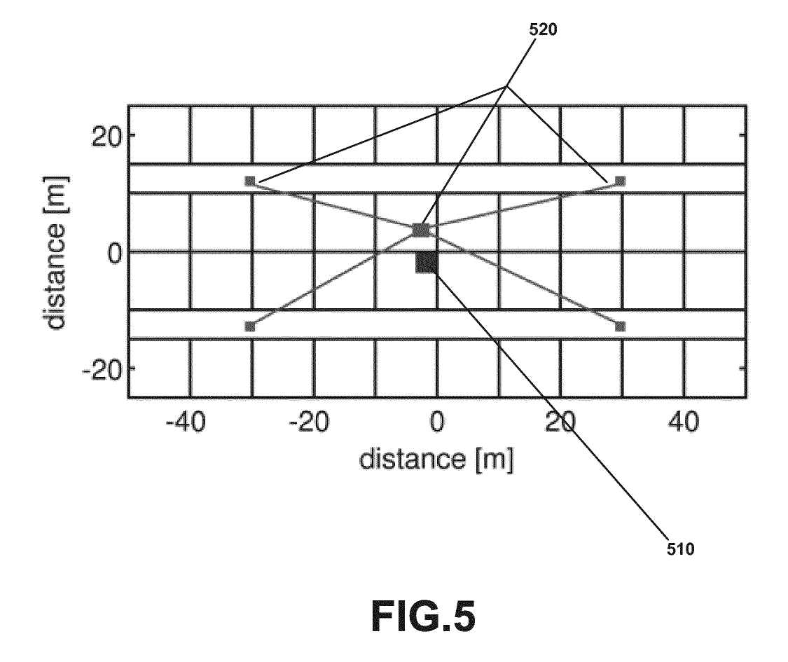

FIG. 5 is a diagram illustrating a massive MIMO deployment and a network MIMO deployment according to an example implementation. One example scenario is the two stripe building, which may be a commonly used model, which has been defined for example in 3GPP and may describe a typical office building, with a central massive Multiple Input, Multiple output (MIMO) access point or base station as shown in FIG. 5. In FIG. 5, a massive MIMO deployment 510 at an access point is shown, as well as a network MIMO deployment 520 wherein signals are transmitted from multiple (or distributed) access points or sources, for example. While a number of the illustrative examples described herein are described, for example, with respect to a single (central) access point, the illustrative principles and techniques apply equally as well to other deployments, such as for network MIMO deployment, for example.

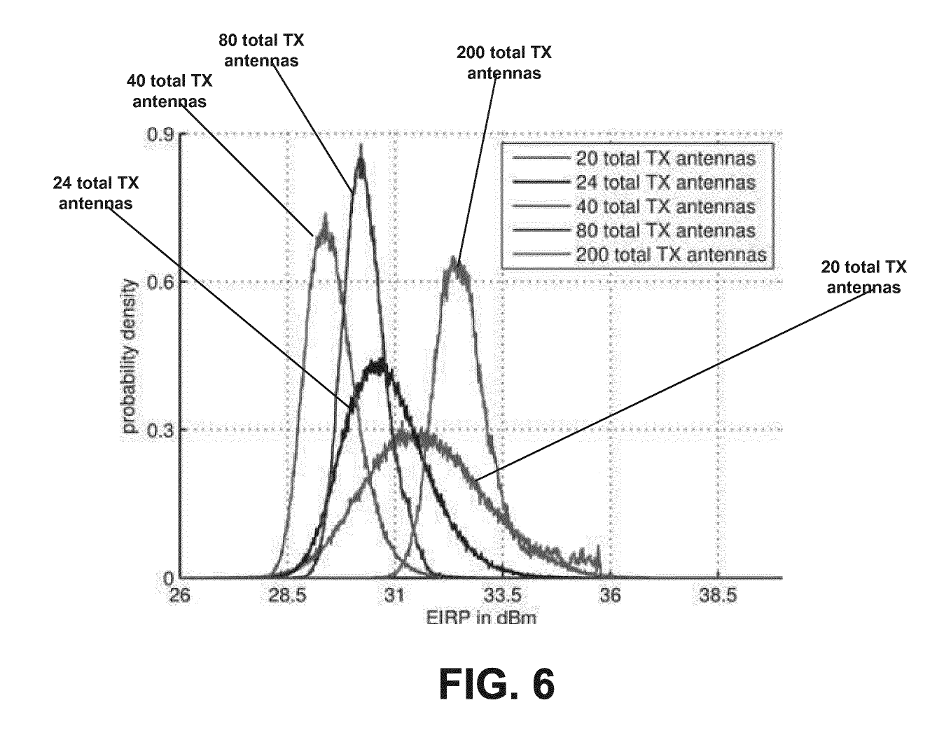

FIG. 6 is a diagram illustrating a histogram of the EIRP with intracell interference zero-forcing, a transmit power of 26 dBm and for 20 receiving user devices for different number of transmit antennas according to an example implementation. Power density For this example indoor scenario, assuming an EIRP constraint of 33 dBm, depending on the number of antenna elements, there are relatively few/infrequent violations of the maximum EIRP. Note however that this is, for example, just a sample of 3000 different channel realizations. There might be worse case channel realizations where the EIRP is much higher. If all signals would interfere constructively in a direction, the maximum EIRP for 200 transmit antennas would be as high as 49 dBm (26 dBm plus 23 dB=10 log₁₀ 200 array gain), for example.

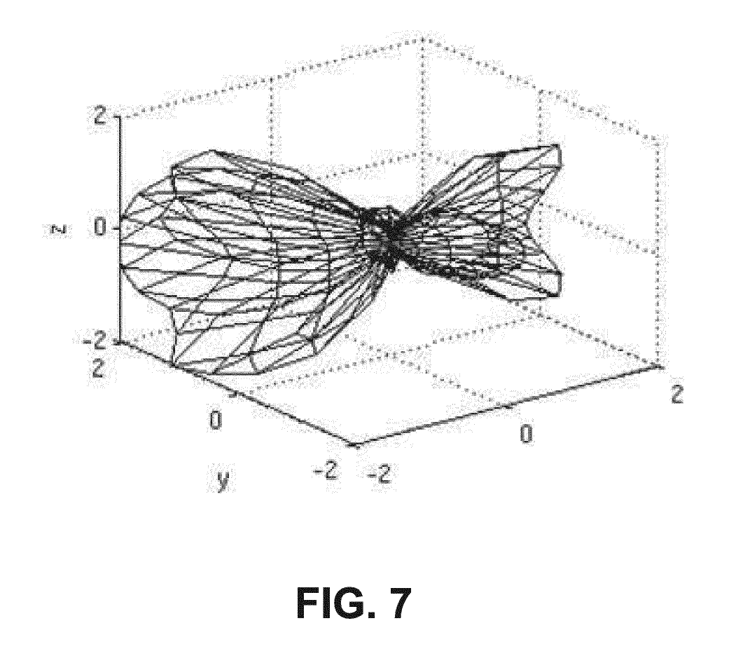

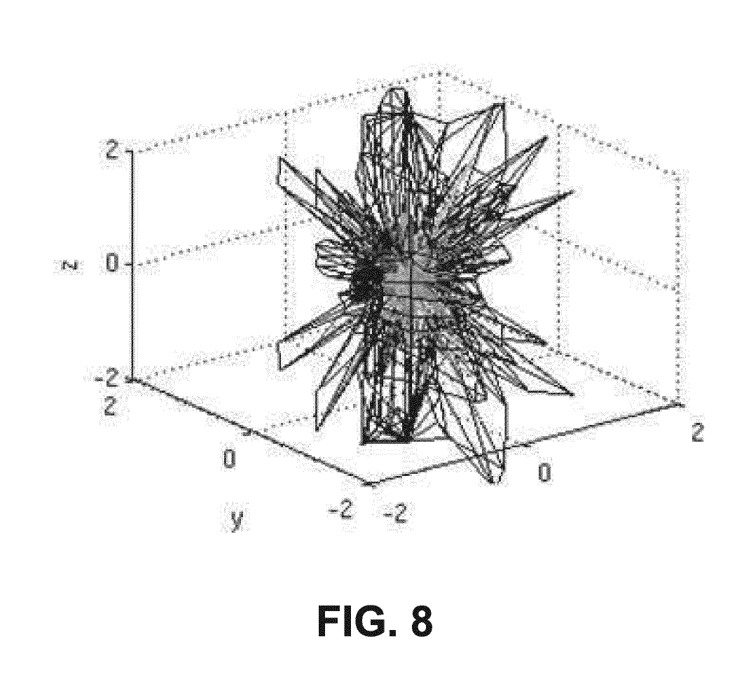

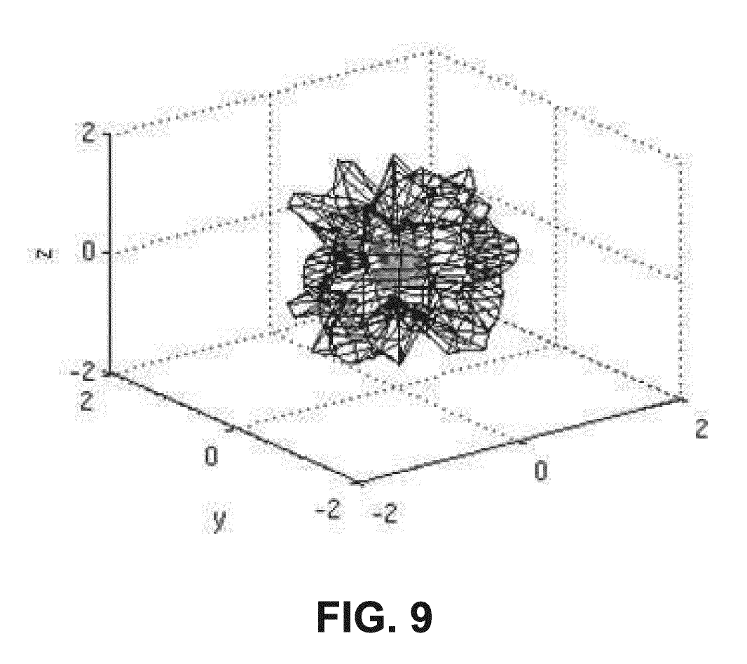

Thus, from FIG. 6, it can be seen that the number of antennas impacts the EIRP. Example transmit power patterns are shown in FIGS. 7-9. FIG. 7 is an example normalized transmit power pattern for 20 transmit antennas. FIG. 8 is an example normalized transmit power pattern for 200 transmit antennas. FIG. 9 is an example normalized transmit power pattern for 40 transmit antennas.

The behavior of the EIRP histograms for different numbers of antennas can be explained. For example, based on the example pattern of the normalized transmitted power in FIG. 7, the individual beams (in the center) do not have a high EIRP. As the beams are broad the overlap of the beams (as the beams extend outwards) creates higher EIRP. In FIG. 8 with 200 transmit antennas, the other extreme is shown where the beams are very narrow, so the chance of overlap is very low. On the other hand the individual beams concentrate power into a direction (narrow/pencil beams) and thus create high EIRP. In FIG. 9 with 40 transmit antennas when designing the precoders there are more degrees of freedom compared to the fully loaded system with 20 transmit antennas, but the concentration of power of the individual beams is not as high as with 200 transmit antennas. Here the EIRP is lower. More antennas provide more degrees of freedom. Thus, with 200 transmit antennas there are many degrees of freedom. This means that more antennas can be used to provide better control of the EIRP for the AP when designing the precoders (when selecting the precoding weights for the various user devices).

An example implementation may include a calculation or measurement of the radiated beam pattern, identifying EIRP violations into certain spatial areas and to adapt the precoding vector(s) (or precoding weights) accordingly such that the EIRP regulations are fulfilled in all relevant spatial directions, for example.

A general approach may be to include the EIRP regulations (e.g., maximum EIRP) as a constraint in the optimization problem when determining the precoders (when determining the precoding weights for each user device), the scheduling and the power allocation. Then, for example, the full transmit power can be used by the AP when transmitting signals to user devices. Mathematically the determination of the precoders (precoding weights for one or more user devices) can be expressed as:

max_{w}_{₁}_{, . . . , w}_{_{K}} f(SINR₁, . . . , SINR_{K}) (Eqn. 1)

subject to: g(w₁, . . . , w_{K})≤P_{EIRP} (Eqn. 2)

(subject to additional constraints (e.g. power constraints)).

Thus, as shown by Eqn. 1, a utility function f may be improved (e.g., maximized) by choosing the precoders or precoding weights w₁, . . . , w_{K}, where the utility function to be improved (e.g., maximized) may include data rate, SINR, or other utility function. As shown by Eqn. 2, the selection of the precoding weights may be selected subject to a power constraint (so as not to violate a power constraint, e.g., so the AP's EIRP does not exceed a maximum EIRP). Note that the SINR and/or data rate may be functions of the precoders/precoding weights (e.g., larger/greater precoding weights for a user device may typically cause a higher transmit signal amplitude, which may typically cause or may allow a higher SINR and/or higher data rate for signals transmitted to the user device).

An example approach or technique may be to calculate or measure the EIRP for a given precoder (for a set of precoding weights) and to reduce the power of the signals causing (or most responsible for) the EIRP violation, e.g., to scale/reduce the respective columns of the precoding matrix, where each column of the precoding matrix may be a precoding vector for a different user device, each precoding vector including a plurality of precoding weights. If the EIRP constraint is violated, the following may be performed by the AP: For the point or direction with maximal power density, the AP determines the relative power contribution to the AP's power density or EIRP, e.g., based on precoding vector/column for each user device/UE. The AP may determine which column(s) (or which precoding vector(s)) of the precoding matrix mainly caused this power density, or are the greatest contributors to the power density or EIRP of the AP. The AP may then reduce the precoding weights of only the identified user device or identified column of the precoding matrix (the precoding weights of a user device) that contribute more to the EIRP than other user devices/precoding vectors. Thus, one or more user devices or precoding vectors that are mostly responsible (contribute more than one or more other user devices/precoding vectors) to the power constraint violation). Thus, rather than adjust or decrease the precoding weights for all user devices/precoding vectors, only the precoding weights for a selected (selected based on relative power contribution to the AP's EIRP) user device/precoding vector are reduced. The process may be repeated or iterated until the EIRP constraint is fulfilled (e.g., the EIRP or maximum power density of the AP does not exceed the maximum EIRP). This way the overall transmit power is only reduced when necessary and only for those users/user devices which create (or contribute the most to) the high EIRP for the AP, while not adjusting/decreasing precoding weights for other user devices/precoding vectors (which contribute less to the EIRP of the AP).

In an example implementation, the maximum power density or EIRP for the AP may be estimated or calculated, for example, based on the precoding weights and a set of antenna parameters. When calculating the EIRP the antenna parameters (e.g., relative antenna positions, antenna pattern per antenna element) should be known or obtained by the AP, as otherwise the direction and strength of the superposition of precoding vectors cannot be estimated. In case of network MIMO where several locally distributed access points cooperate any precoder EIRP limitations should be known at the central unit controlling the cooperation. For that purpose distributed antenna arrays should provide their antenna allocation as well as their individual antenna patterns in a standardized form. Alternatively—if not provided by the antenna provider—the antenna parameters might be measured from reference signals (e.g., from other base stations or from user devices/UEs) or by using calibration antennas. Instead of exchanging transmitter parameters the base stations that coordinate or cooperate could exchange information about EIRP violations.

The superposition of precoding weights or precoding vectors may be estimated based on antenna parameters (e.g., relative antenna positions, antenna pattern per antenna element) so that the direction and strength of the superposition may be estimated. Also, the antenna parameters, which provide the antenna array geometry and/or configuration may, for example, permit calculation of the 3-dimensional transmit (Tx) beam patterns. For example, the EIRP may be calculated as follows: Several/multiple points on a sphere around the antenna array(or directions from the AP) are determined. For each point or direction, the power density is calculated based on the array configuration and the precoding matrix (precoding vectors for each user device, each precoding vector including a set of precoding weights) using the far field assumption. We then determine the maximum power density of these set of power densities, which may be considered the EIRP for the AP, according to an illustrative example.

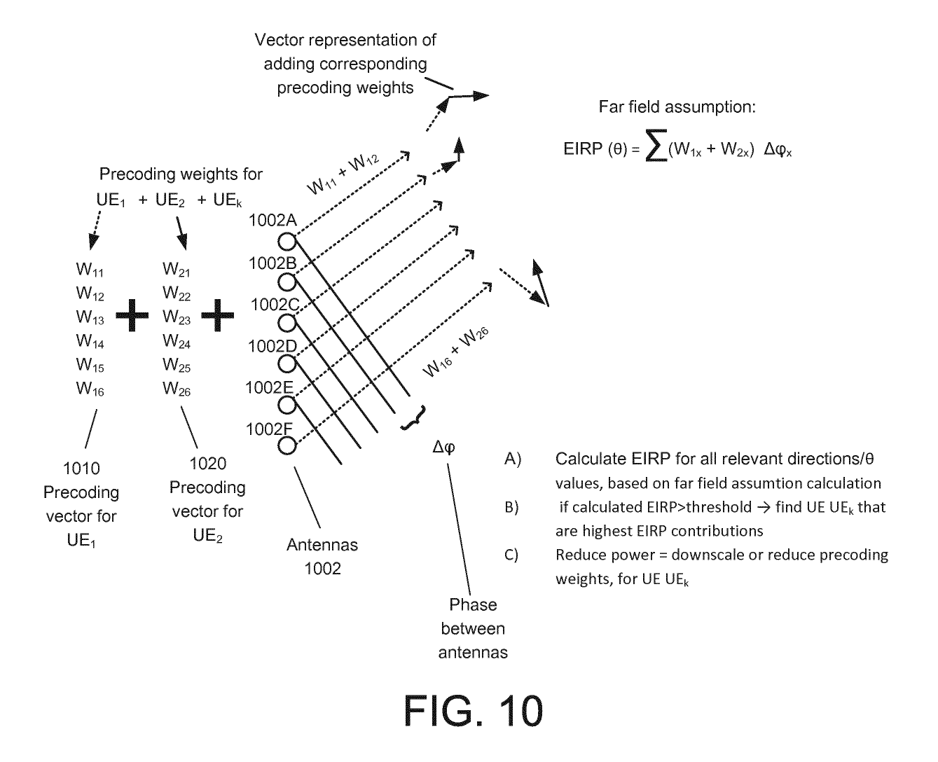

FIG. 10 is a diagram illustrating the application of summed precoding weights for multiple user devices/user equipment (UEs) to antennas according to an example implementation. As shown in FIG. 10, an antenna array for an access point may include antennas 1002, e.g., including antennas 1002A, 1002B, 1002C, 1002D, 1002E and 1002F, for example. While only six antennas are shown for this antenna array, this is merely illustrative, and the antenna array may include any number of antennas.

A precoding matrix or precoder for the AP may include a precoding vector (or column of the precoding matrix) for each of a plurality of user devices/UEs, e.g., in accordance with multi-user MIMO (MU-MIMO). For example, a precoding vector 1010 is shown for UE₁ and includes six weights, e.g., one weight for each of the six antennas, including the following weights: w₁₁ (to be applied to antenna 1002A), w₁₂ (to be applied to antenna 1002B), w₁₃ (to be applied to antenna 1002C), w₁₄ (to be applied to antenna 1002D), w₁₅ (to be applied to antenna 1002E), and w₁₆ (to be applied to antenna 1002F). Similarly, a precoding vector 1020 is shown for UE₂ and includes six weights, e.g., one weight for each of the six antennas, including the following weights: w₂₁ (to be applied to antenna 1002A), w₂₂ (to be applied to antenna 1002B), w₂₃ (to be applied to antenna 1002C), w₂₄ (to be applied to antenna 1002D), w₂₅ (to be applied to antenna 1002E), and w₂₆ (to be applied to antenna 1002F). Although not shown in FIG. 10, precoding vectors (with each vector including a plurality of precoding weights) may be provided for each of a number of other user devices/UEs, e.g., up to UEₖ.

A sum of corresponding precoding weights of the user devices may be applied to each antenna. For example, the weights corresponding to antenna 1002A may be added or summed together and applied to antenna 1002A. For example, the sum of two weights w₁₁+w₂₁ may be applied to antenna 1002A. Similarly, the sum of two weights w₁₆+w₂₆ may be applied to antenna 1002F, as shown in FIG. 10. Each precoding weight may be a complex number, including an amplitude and phase. The precoding weights per user are combined into vectors. Two (or more) precoding vectors are summed up to one common Tx (transmit)-vector as shown in FIG. 10.

A phase between each of the antennas is shown as Δφ. FIG. 10 also shows an example flow or algorithm, shown as operations a), b) and c), for adjusting an EIRP for an access point based on downscaling or decreasing precoding weights for one or more user devices. At operation a), the AP calculates or estimates the power density or EIRP for the AP for a plurality of directions (for each of a plurality of Θ values or directions), based on the far field assumption calculation. There may be a different value for Δφ for each Θ or direction, for example.

With respect to operation a), as shown in FIG. 10, the far field assumption calculation states that:

EIRP (Θ)=Σ(w1x+w2x) Δφₓ, which may be described as:

EIRP (for a direction), or power density=sum of (corresponding weights applied to an antenna x)×(associated phase or angle for antenna x). For example, the associated phase, shown as Δφₓ, may have a maximum value of 1, and may be mathematically represented in the form: ₑ₋ⱼ^{Δφ}ₓ, (which may also be written as: exp(-j*delta-phiₓ) for example, indicating a phase. The phase (or angle) for an antenna may be measured with respect to a reference antenna, such as antenna 1002A. Thus, measured with respect to antenna 1002A, the phase, Δφₓ, for antenna 1002A may be 0; the phase for antenna 1002B may be Δφ; the phase for antenna 1002B may be 2Δφ; . . . , and the phase for antenna 1002F may be 5Δφ, for example. The maximum calculated power density (for all of the directions), or the maximum EIRP for all of the directions, may be considered or used as the EIRP for the AP, for this process or flow, to determine if there is a power constraint violation.

At operation b) of the flow shown in FIG. 10, if the calculated EIRP for the AP is greater than a threshold (e.g., greater than a maximum EIRP), then this indicates a violation of a power constraint, and the AP may find the user devices/UEs that have precoding vectors that have the highest power contribution to the EIRP of the AP. For example, UE₁ (e.g., based on the precoding vector for UE₁) may have the highest power contribution to the AP's EIRP, as compared to other UEs. Thus, in such an illustrative example, the precoding weights for UE₁ may be more responsible for the power constraint violation than any of the other UEs, for example.

At operation c) shown in FIG. 10, according to an example implementation, rather than adjusting (e.g., reducing, decreasing or downscaling) the precoding weights for all of the user devices/UEs, the AP may adjust or decrease the precoding weights for only the highest contributing UE (e.g., UE1 in this example, that has the highest power contribution to the EIRP) that may be most responsible for the power constraint violation, while not adjusting precoding vectors for other UEs, for example.

According to an example implementation, the example techniques or implementations may be applied to massive MIMO base stations/access points for 5G or 4G evolution, and may, for example, be applied to indoor deployments or outdoor small cells (as non-limiting examples) where the base stations/access points may be located close to humans, e.g., such that health issues may be a significant consideration. On the other hand, reducing the transmit power is not always possible as for indoor scenarios the wall penetration loss can be quite high. Thus, the selection of one UE or a subset (and less than all UEs) of UEs for reducing the precoding weights may provide an advantageous solution for a number of example scenarios or network situations. For indoor base stations it might also be possible to change regulations such that higher EIRP is allowed in certain spatial directions (e.g. in directions of walls, preventing that humans are affected by the electro-magnetic waves).

As noted herein, a simple approach is to reduce the transmit power only of those beam(s) (i.e., precoding vectors, or columns of the precoder matrix) which cause the EIRP violations, or which are mostly or more responsible for the EIRP violations, as compared to other beams/UEs. This may allow a reduction in transmit power for one or more offending beams/precoding vectors, while keeping or maintaining the (existing or) higher transmit power for the other beams/precoding vectors.

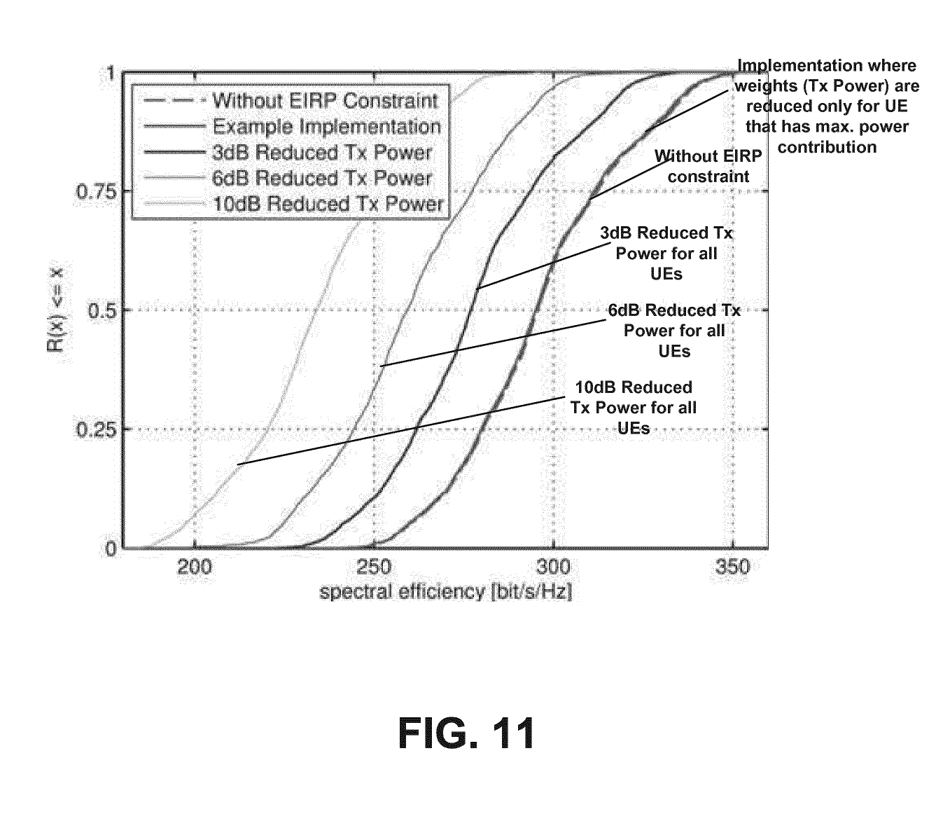

FIG. 11 is a diagram illustrating spectral efficiency of the example implementation that reduces decoding weights for only one UE or a subset of UEs, as compared to spectral efficiency of an EIRP reduction techniques that reduce power for all UEs by a fixed amount, e.g., 3 dB, 6 dB or 10 dB, to avoid EIRP violations. In the diagram of FIG. 11, it assumes an EIRP limit of 33 dBm and 200 transmit antennas. The example implementation performs very close to the unconstrained reference system (no power constraint). Whereas the other techniques perform 18 bits/s/Hz worse for a 3 dB reduction, 36 bits/s/Hz worse for a 6 dB reduction, and 61 bits/s/Hz worse for a 10 dB reduction compared to the example implementation.

In scenarios where some access points or base stations coordinate or cooperate over several locations (e.g., coordinated beamforming, network MIMO) the transmitter parameters should be exchanged to allow maximizing the utility function (e.g., SINR or data rate) subject to the EIRP constraints. The transmitter parameters may include, for example, one or more of the following:
number of antennas
relative antenna positions
vertical/horizontal antennas
antenna pattern
placement relative to wall.

According to an example implementation, the transmitter parameters can be made available to the access point/base station during setup from specifications provided by the antenna manufacturer, or based on other information. It is also possible to measure the parameters, especially the relative antenna positions, with the help of UEs or other base stations, or between different antennas of the same base station after self calibration. The UE measuring process could involve the following steps, for example:
1. Determine UEs with line-of-sight connection and select these UEs
2. Measure relative delay or phase differences between different antennas
3. Feedback delay or phase and the position of the UE to the base station
4. Use calculations including triangulation to determine relative antenna positions

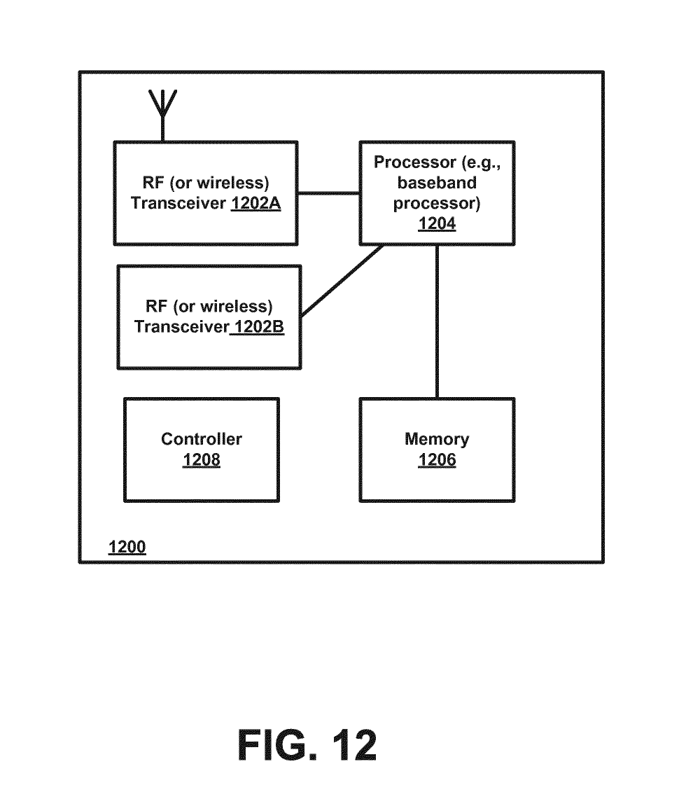

FIG. 12 is a block diagram of a wireless station (e.g., AP or user device) 1200 according to an example implementation. The wireless station 1200 may include, for example, one or two RF (radio frequency) or wireless transceivers 1202A, 1202B, where each wireless transceiver includes a transmitter to transmit signals and a receiver to receive signals. The wireless station also includes a processor or control unit/entity (controller) 1204 to execute instructions or software and control transmission and receptions of signals, and a memory 1206 to store data and/or instructions.

Processor 1204 may also make decisions or determinations, generate frames, packets or messages for transmission, decode received frames or messages for further processing, and other tasks or functions described herein. Processor 1204, which may be a baseband processor, for example, may generate messages, packets, frames or other signals for transmission via wireless transceiver 1202 (1202A or 1202B). Processor 1204 may control transmission of signals or messages over a wireless network, and may control the reception of signals or messages, etc., via a wireless network (e.g., after being down-converted by wireless transceiver 1202, for example). Processor 1204 may be programmable and capable of executing software or other instructions stored in memory or on other computer media to perform the various tasks and functions described above, such as one or more of the tasks or methods described above. Processor 1204 may be (or may include), for example, hardware, programmable logic, a programmable processor that executes software or firmware, and/or any combination of these. Using other terminology, processor 1204 and transceiver 1202 together may be considered as a wireless transmitter/receiver system, for example.

In addition, referring to FIG. 12, a controller (or processor) 1208 may execute software and instructions, and may provide overall control for the station 1200, and may provide control for other systems not shown in FIG. 12, such as controlling input/output devices (e.g., display, keypad), and/or may execute software for one or more applications that may be provided on wireless station 1200, such as, for example, an email program, audio/video applications, a word processor, a Voice over IP application, or other application or software.

In addition, a storage medium may be provided that includes stored instructions, which when executed by a controller or processor may result in the processor 1204, or other controller or processor, performing one or more of the functions or tasks described above.

According to another example implementation, RF or wireless transceiver(s) 1202A/1202B may receive signals or data and/or transmit or send signals or data. Processor 1204 (and possibly transceivers 1202A/1202B) may control the RF or wireless transceiver 1202A or 1202B to receive, send, broadcast or transmit signals or data.

The embodiments are not, however, restricted to the system that is given as an example, but a person skilled in the art may apply the solution to other communication systems. Another example of a suitable communications system is the 5G concept. It is assumed that network architecture in 5G will be quite similar to that of the LTE-advanced. 5G is likely to use multiple input-multiple output (MIMO) antennas, many more base stations or nodes than the LTE (a so-called small cell concept), including macro sites operating in co-operation with smaller stations and perhaps also employing a variety of radio technologies for better coverage and enhanced data rates.

It should be appreciated that future networks will most probably utilise network functions virtualization (NFV) which is a network architecture concept that proposes virtualizing network node functions into “building blocks” or entities that may be operationally connected or linked together to provide services. A virtualized network function (VNF) may comprise one or more virtual machines running computer program codes using standard or general type servers instead of customized hardware. Cloud computing or data storage may also be utilized. In radio communications this may mean node operations may be carried out, at least partly, in a server, host or node operationally coupled to a remote radio head. It is also possible that node operations will be distributed among a plurality of servers, nodes or hosts. It should also be understood that the distribution of labour between core network operations and base station operations may differ from that of the LTE or even be non-existent.

Implementations of the various techniques described herein may be implemented in digital electronic circuitry, or in computer hardware, firmware, software, or in combinations of them. Implementations may implemented as a computer program product, i.e., a computer program tangibly embodied in an information carrier, e.g., in a machine-readable storage device or in a propagated signal, for execution by, or to control the operation of, a data processing apparatus, e.g., a programmable processor, a computer, or multiple computers. Implementations may also be provided on a computer readable medium or computer readable storage medium, which may be a non-transitory medium. Implementations of the various techniques may also include implementations provided via transitory signals or media, and/or programs and/or software implementations that are downloadable via the Internet or other network(s), either wired networks and/or wireless networks. In addition, implementations may be provided via machine type communications (MTC), and also via an Internet of Things (IOT).

The computer program may be in source code form, object code form, or in some intermediate form, and it may be stored in some sort of carrier, distribution medium, or computer readable medium, which may be any entity or device capable of carrying the program. Such carriers include a record medium, computer memory, read-only memory, photoelectrical and/or electrical carrier signal, telecommunications signal, and software distribution package, for example. Depending on the processing power needed, the computer program may be executed in a single electronic digital computer or it may be distributed amongst a number of computers.

Furthermore, implementations of the various techniques described herein may use a cyber-physical system (CPS) (a system of collaborating computational elements controlling physical entities). CPS may enable the implementation and exploitation of massive amounts of interconnected ICT devices (sensors, actuators, processors microcontrollers, . . . ) embedded in physical objects at different locations. Mobile cyber physical systems, in which the physical system in question has inherent mobility, are a subcategory of cyber-physical systems. Examples of mobile physical systems include mobile robotics and electronics transported by humans or animals. The rise in popularity of smartphones has increased interest in the area of mobile cyber-physical systems. Therefore, various implementations of techniques described herein may be provided via one or more of these technologies.

A computer program, such as the computer program(s) described above, can be written in any form of programming language, including compiled or interpreted languages, and can be deployed in any form, including as a stand-alone program or as a module, component, subroutine, or other unit or part of it suitable for use in a computing environment. A computer program can be deployed to be executed on one computer or on multiple computers at one site or distributed across multiple sites and interconnected by a communication network.

Method steps may be performed by one or more programmable processors executing a computer program or computer program portions to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer, chip or chipset. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in, special purpose logic circuitry.

To provide for interaction with a user, implementations may be implemented on a computer having a display device, e.g., a cathode ray tube (CRT) or liquid crystal display (LCD) monitor, for displaying information to the user and a user interface, such as a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

While certain features of the described implementations have been illustrated as described herein, many modifications, substitutions, changes and equivalents will now occur to those skilled in the art. It is, therefore, to be understood that the appended claims are intended to cover all such modifications and changes as fall within the true spirit of the various embodiments.

1. A method of selecting precoding weights in a wireless network to avoid violating a power constraint, the method comprising:
selecting, by an access point in a wireless network, a set of precoding weights subject to a power constraint; and
applying, by the access point, the set of selected precoding weights to a set of antennas to transmit signals to the one or more user devices.

2. The method of claim 1 wherein the selecting comprises:
calculating, by the access point, the set of precoding weights;
determining, by the access point, that the set of precoding weights, when applied to a set of antennas for transmitting signals to the one or more user devices, will violate a power constraint; and
adjusting, by the access point, one or more precoding weights such that the power constraint will not be violated when the access point applies the precoding weights to a set of antennas and transmits signals to the one or more user devices.

3. The method of claim 1 wherein the selecting comprises:
calculating, by the access point, the set of precoding weights for each of a plurality of beamformed signals;
determining, by the access point, that the set of precoding weights for the plurality of beamformed signals, when applied to a set of antennas for transmitting signals to the one or more user devices, will violate a power constraint;
determining, by the access point, that a first set of precoding weights for a first beamformed signal causes a power contribution that is greater than power contributions due to sets of precoding weights of the other beamformed signals;
adjusting, by the access point, one or more precoding weights of the first set of precoding weights for the first beamformed signal such that the power constraint will not be violated when the access point applies the precoding weights, including the adjusted first set of precoding weights, to a set of antennas and transmits signals to the plurality of user devices.

4. The method of claim 1 wherein the selecting comprises:
calculating, by the access point, the set of precoding weights;
determining a set of antenna parameters for an antenna array;
calculating, by the access point, a power density for each of a plurality of directions based on the set of antenna parameters and the set of precoding weights;
determining a maximum power density of the calculated power densities;
comparing the maximum power density to a maximum equivalent isotropically radiated power (EIRP);
adjusting, by the access point if the maximum power density is greater than a maximum equivalent isotropically radiated power (EIRP), one or more precoding weights of at least one of the directions to reduce the maximum power density.

5. The method of claim 1 wherein the selecting comprises at least one of the following:
selecting, by an access point in a wireless network, a set of precoding weights for to maximize a data rate without violating a power constraint; and
selecting, by an access point in a wireless network, a set of precoding weights to maximize a signal-to-interference plus noise ratio (SINR) without violating a power constraint.

6. The method of claim 1 wherein the power constraint comprises:
a maximum power density or an equivalent isotropically radiated power (EIRP) from the access point that is less than or equal to a maximum equivalent isotropically radiated power (EIRP).

7. An apparatus comprising at least one processor and at least one memory including computer instructions, when executed by the at least one processor, cause the apparatus to:
selecting, by an access point in a wireless network, a set of precoding weights subject to a power constraint; and
applying, by the access point, the set of selected precoding weights to a set of antennas to transmit signals to the one or more user devices.

8. A method of selecting precoding weights based on a set of antenna-related parameters, the method comprising:
determining, by an access point in a wireless network, a set of antenna-related parameters;
selecting, by the access point, based on the set of antenna-related parameters, a set of precoding weights to improve a utility function; and
applying, by the access point, the set of selected precoding weights to a set of antennas to transmit signals to the one or more user devices.

9. The method of claim 8 wherein the determining, by an access point in a wireless network, a set of antenna-related parameters for one or more user devices comprises:
storing, by the access point in a memory of the access point, the antenna-related parameters; and
retrieving the antenna-related parameters from memory.

10. The method of claim 9 wherein the antenna-related parameters are specified by one or more antenna vendors or antenna manufacturers.

11. The method of claim 8 wherein the determining, by an access point in a wireless network, a set of antenna-related parameters comprises:
transmitting, by the access point to the one or more user devices, antenna specific reference signals used for the estimation of antenna-related channel state information at user devices;
receiving, by the access point, from the one or more user devices, the accordingly estimated channel state information to the access point, together with user device location information; and
determining, by the access point, the antenna-related parameters based on the channel state information and the user device location information received from the one or more user devices.

12. The method of claim 8 wherein the selecting comprises:
selecting, by the access point in a wireless network, a set of precoding weights for each of one or more user devices to improve a utility function and avoid violating a power constraint.

13. The method of claim 8 wherein the antenna-related parameters comprise parameters that indicate or describe one or more of the following:
geometrical allocation of antenna elements;
beam patterns per antenna element; and
other antenna characteristics.

14. The method of claim 8 wherein the selecting comprises at least one of the following:
selecting, by an access point in a wireless network, a set of precoding weights to improve a data rate or SINR (signal-to-interference plus noise ratio);
selecting, by an access point in a wireless network, a set of precoding weights to improve energy efficiency; and
selecting, by an access point in a wireless network, a set of precoding weights to improve wireless coverage for one or more user devices.

15. The method of claim 8 wherein the selecting is performed subject to a power constraint.

16. The method of claim 8 wherein the selecting comprises:
selecting, by an access point in a wireless network, a set of precoding weights subject to a plurality of directional power constraints, with each directional power constraint indicating a maximum power for a different direction.

17. The method of claim 16 wherein the directional power constraints vary depending on time, location, placement, surrounding or other criteria.

18. The method of claim 8 wherein the selecting comprises:
calculating, by the access point, the set of precoding weights;
determining, by the access point, that the set of precoding weights, when applied to a set of antennas for transmitting signals to the one or more user devices, will violate a power constraint; and
adjusting, by the access point, one or more precoding weights such that the power constraint will not be violated when the access point applies the precoding weights to a set of antennas and transmits signals to the one or more user devices.

19. The method of claim 8 wherein the selecting comprises:
calculating, by the access point, the set of precoding weights for each of a plurality of beamformed signals;
determining, by the access point, that the set of precoding weights for the plurality of beamformed signals, when applied to a set of antennas for transmitting signals to the one or more user devices, will violate a power constraint;
determining, by the access point, that a first set of precoding weights for a first beamformed signal causes a power contribution that is greater than power contributions due to sets of precoding weights of the other beamformed signals;
adjusting, by the access point, one or more precoding weights of the first set of precoding weights for the first beamformed signal such that the power constraint will not be violated when the access point applies the precoding weights, including the adjusted first set of precoding weights, to a set of antennas and transmits signals to the plurality of user devices.

20. The method of claim 8 wherein the selecting comprises:
calculating, by the access point, the set of precoding weights
determining a set of antenna-related parameters for an antenna array;
calculating, by the access point, a power density for each of a plurality of directions based on the set of antenna-related parameters and the set of precoding weights;
determining a maximum power density of the calculated power densities;
comparing the maximum power density to a maximum equivalent isotropically radiated power (EIRP);
adjusting, by the access point if the maximum power density is greater than a maximum equivalent isotropically radiated power (EIRP), one or more precoding weights of at least one of the directions to reduce the maximum power density.

21. An apparatus comprising at least one processor and at least one memory including computer instructions, when executed by the at least one processor, cause the apparatus to:
determine, by an access point in a wireless network, a set of antenna-related parameters;
select, by the access point, based on the set of antenna-related parameters, a set of precoding weights to improve a utility function; and
apply, by the access point, the set of selected precoding weights to a set of antennas to transmit signals to the one or more user devices.
